(19) United States
(12) Patent Application Publication
(10) Pub. No.: US 2024/0198751 A1
(43) Pub. Date: Jun. 20, 2024

(54) SYSTEM, APPARATUS, AND METHOD FOR A REGENERATIVE DEVICE

(71) Applicant: Guident Ltd., London (GB)

(72) Inventors: Craig Ades, Boca Raton, FL (US); Harald Braun, Highland Beach, FL (US); Michael J. Trank, Pompano Beach, FL (US); Gabriel Castaneda, Pompano Beach, FL (US)

(21) Appl. No.: 18/068,976

(22) Filed: Dec. 20, 2022

(51) Int. Cl. B60G 17/06

(52) U.S. Cl. CPC B60G 17/06; B60G 2202/42; B60G 2500/10; B60G 2600/73

(57) ABSTRACT

A method for controlling a mechanical assembly that includes a damping assembly is disclosed. The method includes providing one or more sensors at at least one of the mechanical assembly or a generator assembly that is operably connected to the mechanical assembly, providing an electrical circuit that is electrically connected to the generator assembly, sensing data of the at least one of the mechanical assembly or the generator assembly using the one or more sensors, varying an electrical load on the generator assembly using the electrical circuit based on the sensed data, and varying a mechanical force transferred between the generator assembly and the mechanical assembly based on varying the electrical load.

### TECHNICAL FIELD

The present disclosure generally relates to a system, apparatus, and method for a regenerative device, and more particularly to a regenerative shock absorber in at least some exemplary embodiments.

### BACKGROUND

A shock absorber or damper usually serves as part of a vehicle suspension, typically along with springs. A shock absorber or damper may absorb and dampen vibrations, oscillation of springs, and shock impulses. The shock absorber accomplishes this by converting kinetic energy, such as wasted vibration energy due to a vehicle's movement over a surface, into other energy forms such as heat.

A shock absorber for a vehicle often contains spring-loaded check valves and orifices to control an oil flow through a piston of the shock absorber. Shock absorbers may include a dashpot that may provide damping based on viscous friction. Conventional shock absorbers dissipate wasted vibration energy as heat. Rather than waste such energy, regenerative shock absorbers convert wasted vibration energy into mechanical energy, which can then be used to drive a generator for generating electricity.

Regenerative shock absorbers typically operate in a fixed or static manner, which does not involve varying or controlling characteristics of the regenerative shock absorber. For example, based on shortcomings in conventional regenerative shock absorber design for controlling and varying damping characteristics, conventional regenerative shock absorbers typically do not operate simultaneously as both effective regenerative energy devices and effective shock absorbers. That is, in conventional regenerative energy devices, the use of a shock absorber as a regenerative energy device often decreases the effectiveness of the device's performance as a shock absorber or vice versa.

The exemplary disclosed system, apparatus, and method are directed to overcoming one or more of the shortcomings set forth above and/or other deficiencies in existing technology.

### SUMMARY OF THE DISCLOSURE

In one exemplary aspect, the present disclosure is directed to a method for controlling a mechanical assembly that includes a damping assembly. The method includes providing one or more sensors at at least one of the mechanical assembly or a generator assembly that is operably connected to the mechanical assembly, providing an electrical circuit that is electrically connected to the generator assembly, sensing data of at least one of the mechanical assembly or the generator assembly using one or more sensors, varying an electrical load on the generator assembly using the electrical circuit based on the sensed data, and varying a mechanical force transferred between the generator assembly and the mechanical assembly based on varying the electrical load.

In another aspect, the present disclosure is directed to an apparatus configured to be connected to a generator assembly and a damping assembly. The apparatus includes a conversion assembly configured to be operably connected between the generator assembly and the damping assembly, a structural member operably connecting the conversion assembly and the generator assembly, an electrical circuit that is configured to be electrically connected to the generator assembly, and one or more sensors configured to sense at least one of the generator assembly or the damping assembly. The electrical circuit is configured to vary an electrical load on the generator assembly based on the sensing of one or more sensors. Varying the electrical load on the generator assembly varies the mechanical force transferred by the structural member.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still be within the spirit of the disclosure as described herein.

FIG. 1 illustrates a schematic view of at least some exemplary embodiments of the present disclosure;

FIG. 2 illustrates a front view of at least some exemplary embodiments of the present disclosure;

FIG. 3 illustrates a schematic view of at least some exemplary embodiments of the present disclosure;

FIG. 4 illustrates a sectional view of at least some exemplary embodiments of the present disclosure;

FIG. 5 illustrates a perspective view of at least some exemplary embodiments of the present disclosure;

FIG. 6 illustrates a schematic view of at least some exemplary embodiments of the present disclosure;

FIG. 7 illustrates an exemplary process of at least some exemplary embodiments of the present disclosure;

FIG. 8 illustrates a view of exemplary performance data associated with at least some exemplary embodiments of the present disclosure;

FIG. 9 illustrates a view of exemplary performance data associated with at least some exemplary embodiments of the present disclosure;

FIG. 10 is a schematic illustration of an exemplary computing device, in accordance with at least some exemplary embodiments of the present disclosure; and

FIG. 11 is a schematic illustration of an exemplary network, in accordance with at least some exemplary embodiments of the present disclosure.

### DETAILED DESCRIPTION AND INDUSTRIAL APPLICABILITY

The exemplary disclosed system, apparatus, and method may include a regenerative energy system and a damping system. In at least some exemplary embodiments, the exemplary disclosed system, apparatus, and method may include any suitable system for providing regenerative energy based on an operation of a damping system such as, for example, a regenerative shock absorber, a regenerative energy damping device (e.g., for any suitable type of vehicle, building, bridge, and/or any other desired system or assembly), and/or any other suitable system that may include both damping and regenerative energy operations.

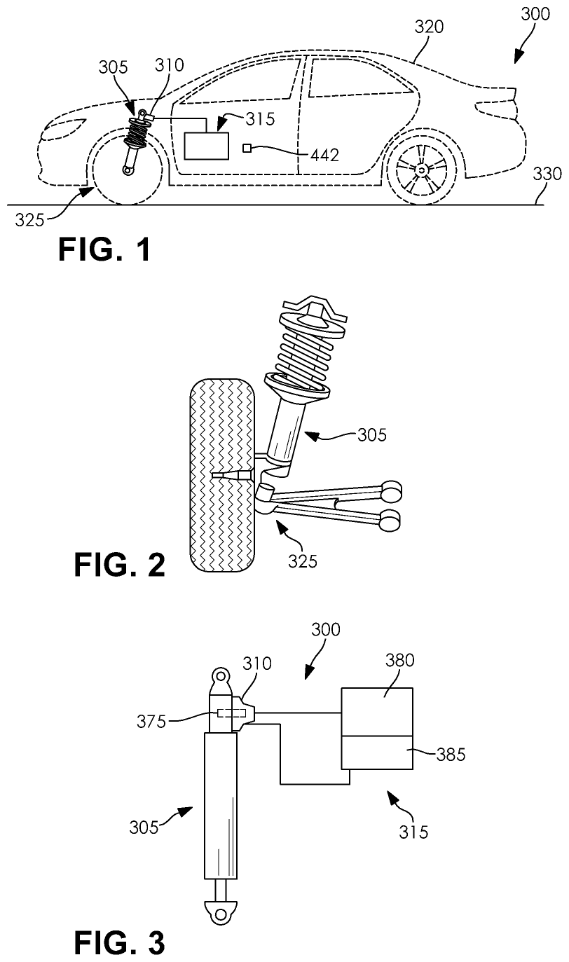

In at least some exemplary embodiments and as illustrated in FIGS. 1-6, the exemplary disclosed system, apparatus, and method may include a system 300. System 300 may include a mechanical assembly 305, a generator assembly 310, and a control system 315. Control system 315 may control mechanical assembly 305 and generator assembly 310. For example, control system 315 may control (e.g., indirectly control) mechanical assembly 305 based on control (e.g., direct control) of generator assembly 310.

Mechanical assembly 305 may include any suitable damping and/or regenerative energy device. For example, mechanical assembly 305 may include a shock absorber. Mechanical assembly 305 may include a regenerative shock absorber. Mechanical assembly 305 may include a damper device and a regenerative energy device. Mechanical assembly 305 may be any suitable assembly for converting vibration energy into mechanical energy.

As illustrated in FIGS. 1-3, mechanical assembly 305 may be attached to and/or integrated into a body 320. Body 320 may be any desired mechanical body such as, for example, a vehicle (automobile or truck), marine vessel (e.g., surface vessel or submersible vessel), aircraft (e.g., fixed wing or rotary wing aircraft), building, bridge, or any other desired structure. For example, body 320 may be a vehicle such as a car having a wheel assembly 325. In at least some exemplary embodiments, mechanical assembly 305 may include a shock absorber (e.g., regenerative shock absorber) attached to wheel assembly 325. For example, mechanical assembly 305 may operate to absorb and dampen vibrations, oscillation of springs, and/or shock impulses of wheel assembly 325 and/or body 320 as body 320 moves across a surface portion 330 such as a road, dirt surface, or any other desired terrain.

Mechanical assembly 305 may include any suitable damping assembly and any suitable conversion assembly for converting vibrations and other energy associated with wheel assembly 325 and/or body 320 into mechanical energy for driving generator assembly 310. The damping assembly may include a viscous damping device and/or a hysteretic damping device. The damping device may include an air friction damping device, an electromagnetic damping device, a fluid friction damping device, a tuned mass damping device, a yielding damping device, a magnetic damping device, an eddy current damping device, and/or any other suitable damping device. The conversion assembly may include any suitable mechanical components such as gears, ball screws, and/or any other suitable mechanical components. The conversion assembly may include piezoelectric components, resonators, transducers, and/or any other suitable components for converting vibration energy and/or any other suitable energy associated with body 320 and wheel assembly 325 to mechanical energy.

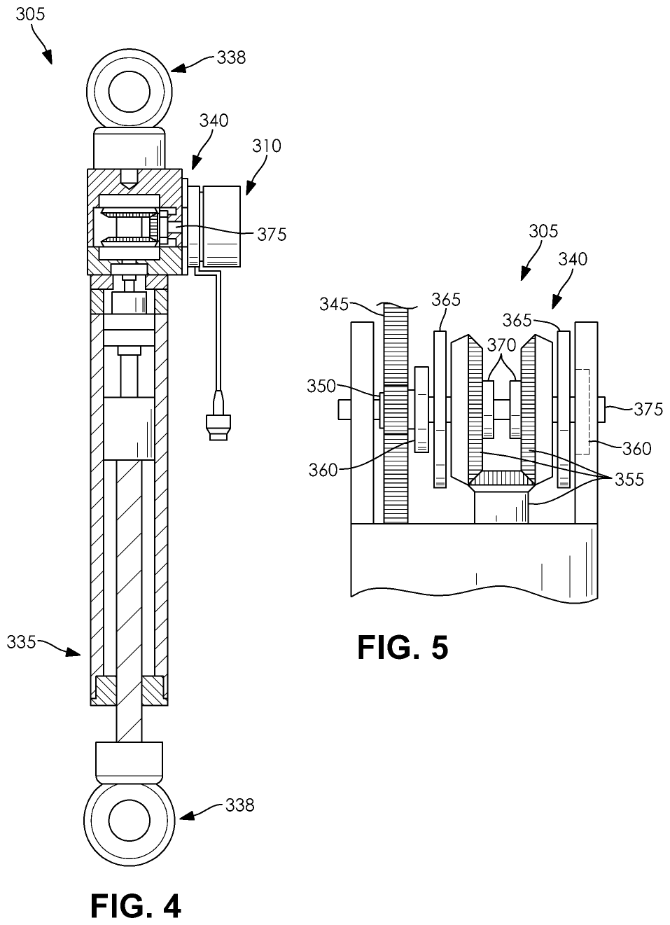

FIGS. 4 and 5 illustrate one of many different exemplary embodiments (e.g., as set forth above) of mechanical assembly 305. For example, mechanical assembly 305 may include a damping assembly 335 and a conversion assembly 340. In at least some exemplary embodiments, damping assembly 335 may be a shock absorber. For example, damping assembly 335 may be a viscous shock absorber including a piston and attachment structural members 338 for attachment to wheel assembly 325. Damping assembly 335 may be operably attached (e.g., mechanically attached) to conversion assembly 340.

As illustrated in FIGS. 4 and 5, conversion assembly 340 may be a mechanical conversion assembly. Conversion assembly 340 may be a mechanical motion rectifier. In at least some exemplary embodiments, conversion assembly 340 may include a ball screw for converting vibration energy from damping assembly 335 into mechanical energy to drive generator assembly 310. In at least some exemplary embodiments, conversion assembly 340 may include a rack 345 and a pinion 350 that may be operably connected so that rack 345 moves relative to pinion 350. Conversion assembly 340 may also include a plurality of bevel gears 355 that may be operably connected to damping assembly 335 and may rotate based on a movement of components of damping assembly 335. Conversion assembly 340 may also include a plurality of ball bearings 360, thrust bearings 365, and one-way clutches 370 that may be operably connected to bevel gears 355 and may operate to rotate a structural member such as a shaft member 375 based on the rotation of bevel gears 355. Conversion assembly 340 may thereby operate to convert vibration and other suitable energy of damping assembly 335 into mechanical energy (e.g., in the form of rotating shaft member 375). Rotation of shaft member 375 (e.g., a rotation 8) by conversion assembly 340 may drive generator assembly 310. In at least some exemplary embodiments, shaft member 375 may have a D-shaped cross-section (e.g. or any other desired cross-section) for facilitating an operable, mechanical connection between conversion assembly 340 and generator assembly 310.

Generator assembly 310 may be any suitable device for generating electricity based on being driven by mechanical energy and/or any other suitable type of energy. For example, generator assembly 310 may be an induction generator or a synchronous generator. Generator assembly 310 may be a shaft motor. Generator assembly 310 may also be driven by any other suitable type of energy based on an operation of conversion assembly 340. Generator assembly 310 may include stators, coils, and/or any other suitable generator components. Generator assembly 310 may include an AC or a DC motor generator. Generator assembly 310 may be a 3-phase motor generator. Generator assembly 310 may be any suitable type of motor-generator such as, for example, commutator, squirrel cage, wound rotor, shunt, separately excited, series, PMDC, stepper, servo, brushless, universal, reluctance, and/or any other suitable type of motor-generator. Generator assembly 310 may be electrically connected to control system 315 for example as described below.

Generator assembly 310 may be electrically connected with, and supply generated electrical energy to, any suitable component of system 300 and/or body 320 (e.g., an electrical component 425). Electrical component 425 may be a battery or any other suitable electrical component that may be directly or indirectly powered by generator assembly 310. For example, electrical component 425 may include a battery and/or any other suitable power device. For example, electrical component 425 may include a battery (e.g., a disposable or a rechargeable battery) such as a nickel-metal hydride battery, a lithium-ion battery, an ultracapacitor battery, a lead-acid battery, and/or a nickel-cadmium battery.

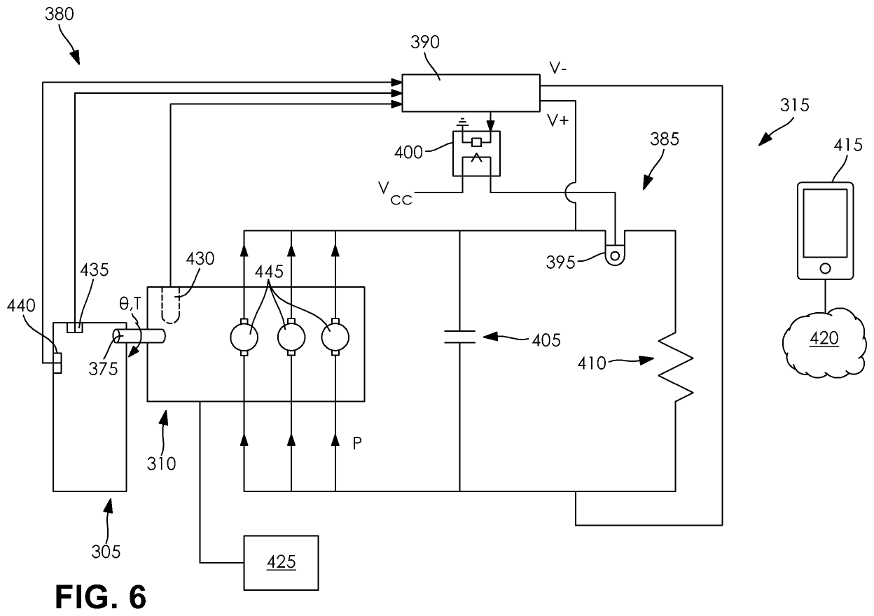

Control system 315 may be any suitable electrical system for controlling mechanical assembly 305 based on the control of generator assembly 310. Control system 315 may include one or more electrical circuits for example as illustrated in FIG. 6.

As illustrated in FIG. 6, control system 315 may include a control subsystem 380 and a switch subsystem 385. Control subsystem 380 may include a controller 390. Switch subsystem 380 may be any suitable subsystem for varying an operation of generator assembly 310 by varying a force T (e.g., a torque T) associated with shaft member 375. For example in at least some exemplary embodiments, switch subsystem 385 may include a switch 395, a driver 400, a capacitor 405, and a resistor 410. Switch subsystem 385 may alternatively include any other components and/or configurations for varying the operation of generator assembly 310. Control subsystem 380 may control switch subsystem 385 to vary the operation of generator assembly 310. Control system 315 may operate using any suitable technique such as, for example, using a variable resistor, pulse-width modulation, and/or any other suitable technique for varying an electrical load (e.g., a resistive load) applied to the exemplary disclosed circuit (e.g., and generator assembly 310) of control system 315. For example, in at least some exemplary embodiments, control system 315 may be a Pulse Width Modulation (PWM) MOSFET switching circuit.

Controller 390 may be disposed at any suitable location of body 320. Controller 390 may include for example a processor (e.g., micro-processing logic control device) and/or board components. Also, for example, controller 390 may include input/output arrangements that allow it to be connected (e.g., via electrical line or wire, wireless, Wi-Fi, Bluetooth, or any other suitable communication technique) to other components of system 300. For example, controller 390 may control an operation of system 300 based on input received from an exemplary disclosed module of system 300 (e.g., as described below), a user device 415, and/or input provided directly to system 300 via a user interface provided on body 320 (e.g., via any suitable user interface such as a switch, keypad, button, and/or a touchscreen for example as described below). Controller 390 may communicate with components of system 300 via electrical line or wire, wireless communication, Wi-Fi, Bluetooth, network communication (e.g., via a network 420), internet, and/or any other suitable technique (e.g., as disclosed herein).

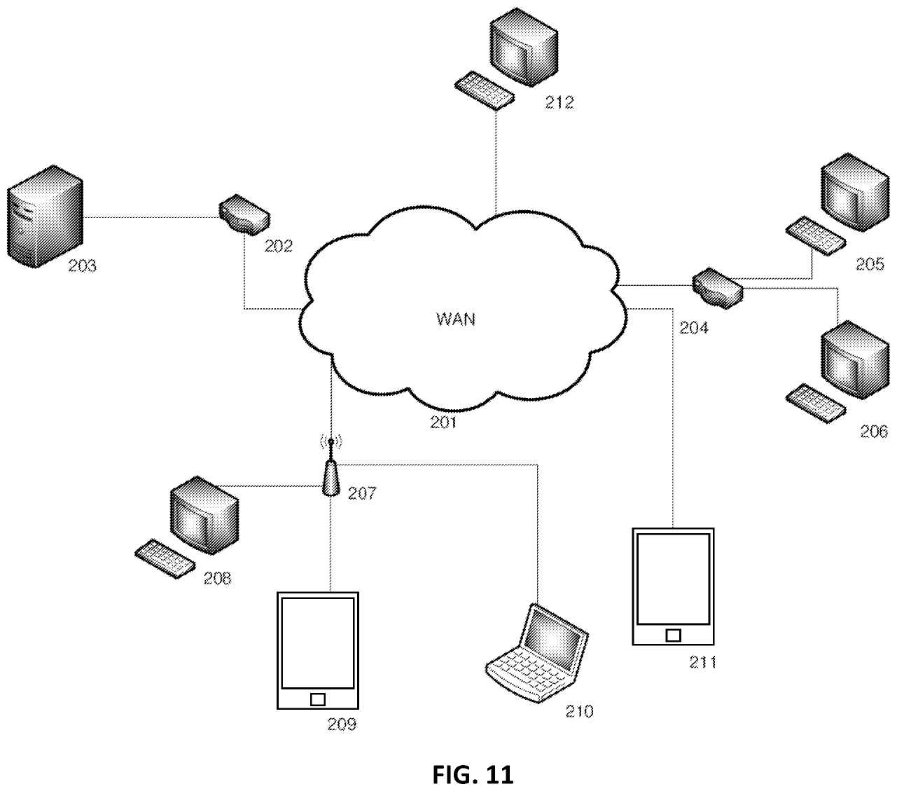

Network 420 may be any suitable network such as the exemplary disclosed network described below regarding FIG. 11. Network 420 may be any suitable communication network over which data may be transferred between components of system 300 and/or body 320. Network 420 may be the internet, a LAN (e.g., via Ethernet LAN), a WAN, a Wi-Fi network, or any other suitable network. Network 420 may be similar to WAN 201 described below. The components of system 300 may also be directly connected (e.g., by electrical line or wire, cable, USB connection, wireless, and/or any other suitable electro-mechanical connection) to each other and/or connected via network 420. For example, components of system 300 may wirelessly transmit data by any suitable technique such as, e.g., wirelessly transmitting data via 4G LTE networks (e.g., or 5G networks) or any other suitable data transmission technique for example via network communication. Components of system 300 may transfer data via the exemplary techniques described below regarding FIG. 11. User device 415 and/or any other suitable component of system 300 may include integrally formed communication devices that may communicate using any of the exemplary disclosed communication techniques (e.g., directly with each other and/or via network 420).

User device 415 may be any suitable user device for receiving input and/or providing output (e.g., raw data or other desired information) to a user. User device 415 may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of system 300, and/or any other suitable user device or interface. For example, user device 415 may include a touchscreen device of a smartphone or handheld tablet. For example, user device 415 may include a display that may include a graphical user interface to facilitate the entry of input by a user and/or receiving the output. For example, system 300 may provide notifications to a user via output transmitted to user device 415. User device 415 may communicate with components of system 300 by any suitable technique such as, for example, as described herein.

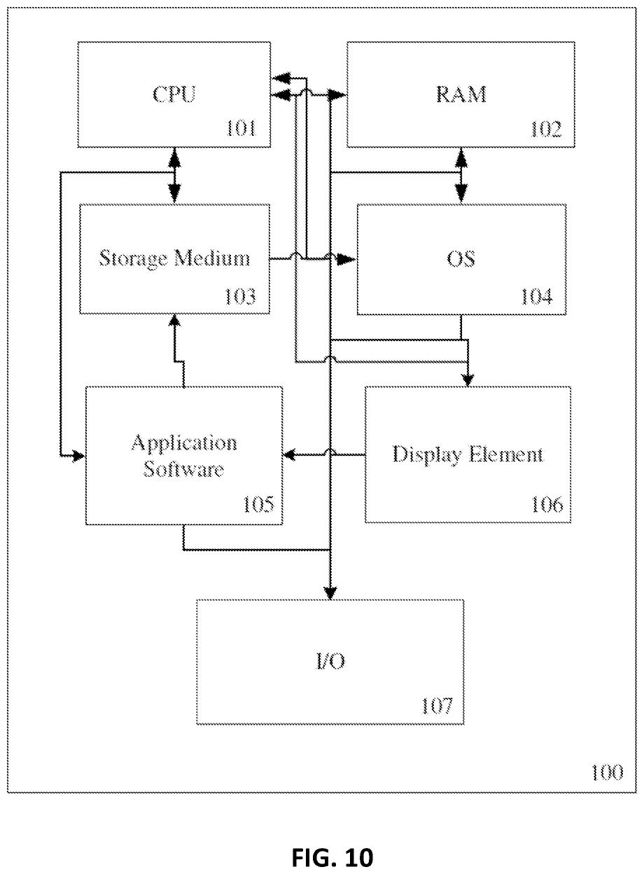

System 300 may include one or modules for performing the exemplary disclosed operations. The one or more modules may include an accessory control module for controlling system 300. The one or more modules may be stored and operated by any suitable components of system 300 (e.g., including processor components) such as, for example, controller 390, network 420, user device 415, and/or any other suitable component of system 300. For example, system 300 may include one or more modules having computer-executable code stored in non-volatile memory. System 300 may also include one or more storages (e.g., buffer storages) that may include components similar to the exemplary disclosed computing device and network components described below regarding FIGS. 10 and 11. For example, the exemplary disclosed buffer storage may include components similar to the exemplary storage medium and RAM described below regarding FIG. 10. The exemplary disclosed buffer storage may be implemented in software and/or a fixed memory location in the hardware of system 300. The exemplary disclosed buffer storage (e.g., a data buffer) may store data temporarily during an operation of system 300.

Controller 390 may be connected to one or more sensors of control subsystem 380. For example, controller 390 may be electrically and/or communicatively connected (e.g., via wire, wireless, and/or any of the communication techniques described herein) to a rotation sensor 430 that may be disposed at generator assembly 310, a force sensor 435 that may be disposed at mechanical assembly 305 (e.g., at damping assembly 335), a position sensor 440 that may be disposed at mechanical assembly 305 (e.g., at damping assembly 335), and/or any other desired sensors (e.g., temperature, vibration, and/or any other desired parameters such as, for example, one or more vehicle sensors 442 as illustrated in FIG. 1). One or more vehicle sensors 442 may include for example an engine knock sensor, a throttle position sensor, an engine speed sensor, a GPS sensor, a mass air-flow sensor, an oil level or pressure sensor, an altimeter, a temperature sensor, an intake air temperature sensor, an oxygen sensor, a pressure sensor, a Nox sensor, and/or any other desired type of vehicle sensor. Returning to FIG. 6, data may be transferred between controller 390 and sensors 430, 435, and 440 (e.g., and/or vehicle sensors 442), including for example sensed data that may be transferred to controller 390 for processing.

Rotation sensor 430 may be any suitable sensor for measuring rotation (e.g., rotations per minute or any other desired data such as of rotation θ) of shaft member 375. Rotation sensor 430 may include a tachometer, a shaft encoder, a rotary displacement sensor, a proximity sensor, a photoelectric sensor, a rotary pulse generator, an optical sensor (e.g., a laser tachometer), a stroboscopic sensor, a magneto resistive speed sensor, a variable reluctance speed sensor, and/or any other suitable sensing devices for measuring rotation.

Force sensor 435 may be any suitable sensor for measuring a force applied by mechanical assembly 305 (e.g., damping assembly 335) to an external body (e.g., a component of wheel assembly 325). Force sensor 435 may include a triaxial force sensor, a load cell sensor, a transducer, a plate force sensor, a dynamometer, and/or any other suitable sensing devices for measuring the force applied by mechanical assembly 305.

The position sensor 440 may be any suitable sensor for measuring a position of mechanical assembly 305 (e.g., relative to components of wheel assembly 325 and/or a position of components of mechanical assembly 305 relative to each other). Position sensor 440 may include a servo accelerometer, a piezoelectric accelerometer, a potentiometric accelerometer, a strain gauge accelerometer, a linear position sensor, an optical displacement sensor, an ultrasonic displacement sensor, a gyroscope, a pressure sensor, a transducer, and/or any other suitable sensing devices for measuring a position of mechanical assembly 305.

Switch 395, driver 400, capacitor 405, and resistor 410 may be any suitable components for varying an electrical load P (e.g., a resistive load P) applied to a circuit of control system 315 (e.g., as illustrated in FIG. 6). Switch 395, driver 400, capacitor 405, and resistor 410 may be electrically connected to generator components 445 for example as illustrated in FIG. 6 (e.g., a one-way electrical flow may be provided relative to generator components 445, for example via diodes). Generator components 445 may be any suitable components of generator assembly 310 such as, for example, coil windings associated with three phases of generator assembly 310. Capacitor 405 may be a fixed capacitor or a variable capacitor. Capacitor 405 may be a film capacitor, a ceramic capacitor, a polycarbonate capacitor, a glass capacitor, an electrolytic capacitor, and/or any other suitable type of capacitor (e.g., for smoothing a voltage of the circuit of control system 315). Resistor 410 may be a fixed value resistor or a variable resistor. Resistor 410 may be a metal strip resistor, a metal oxide resistor, a carbon film resistor, a wirewound resistor, a metal film resistor, and/or any other suitable resistor. Switch 395 may be a transistor. Switch 395 may be a MOSFET, an IGBT, or a TRIAC relay. Switch 395 may be a MOSFET transistor using pulse-width modulation. Driver 400 may include an opto-isolator. Driver 400 may be a power MOSFET driver, a high-side gate driver, a low-side gate driver, a half-bridge driver, a full-bridge driver, and/or any suitable driver for providing power to switch 395. Driver 400 may utilize any suitable power source (e.g., Vcc) such as, for example, 5V, 10V, or any other suitable voltage.

The exemplary disclosed system, apparatus, and method may be used in any suitable application for energy harvesting. The exemplary disclosed system, apparatus, and method may be used in any suitable application for providing damping to a mechanical system or structure. For example, the exemplary disclosed system, apparatus, and method may be used in any suitable application for a regenerative energy damping device such as, for example, a shock absorber for a vehicle, a damping device for a structure such as a building or bridges, and/or any other suitable application for harvesting energy and/or reducing vibration. The exemplary disclosed system, apparatus, and method may be used in any suitable application for simultaneously providing both desired energy regeneration and desired damping.

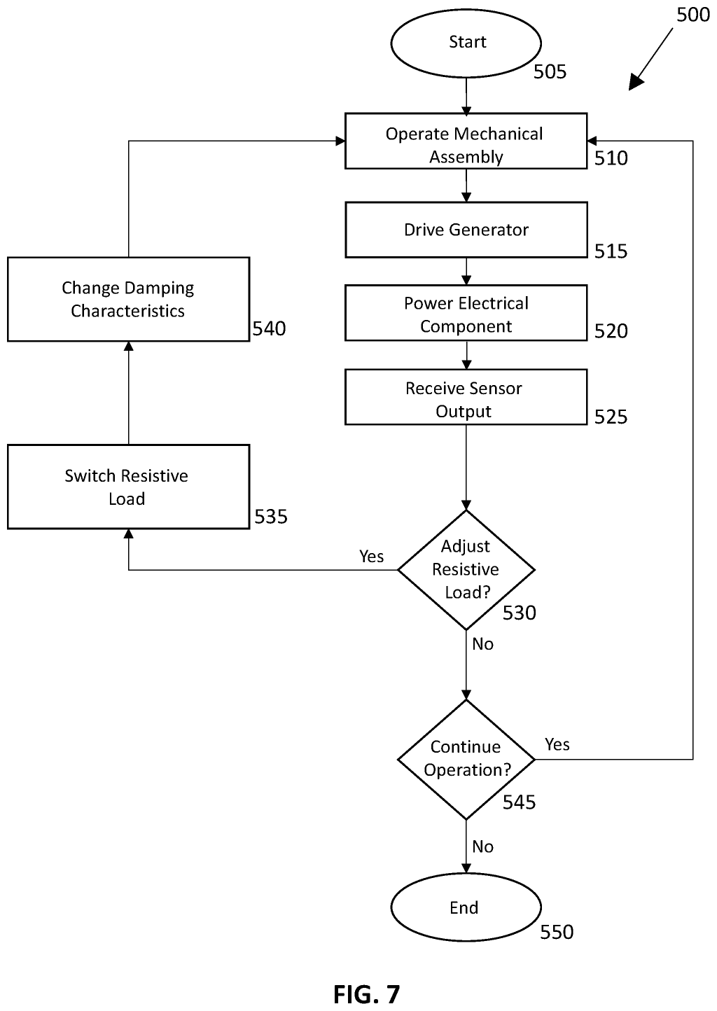

FIG. 7 illustrates an exemplary operation (e.g., algorithm) of exemplary disclosed system 300. Process 500 begins at step 505.

At step 510, mechanical assembly 305 may operate to absorb and dampen vibrations, oscillation of springs, and/or shock impulses of wheel assembly 325 and body 320 as body 320 moves across surface portion 330 (e.g., or moves through the air or water or is as structure moved by external forces such as wind or an earthquake). As damping assembly 335 operates to absorb and dampen vibrations, oscillation of springs, and/or shock impulses, damping assembly 335 may drive conversion assembly 340 for example as described above. Conversion assembly 340 may convert vibration and other energy associated with damping assembly 335 into mechanical energy (e.g., or any other suitable form of energy for driving generator assembly 310) for example as described above.

At step 515, the mechanical energy (e.g., or any other suitable energy) of conversion assembly 340 may drive generator assembly 310. For example, conversion assembly 340 may drive generator assembly 310 by transferring mechanical energy via rotation of shaft member 375. In at least some exemplary embodiments, shaft member 375 may spin and together with one or more stators, wiring, and/or other components of generator assembly 310 (e.g., including generator components 445) generate electricity. Conversion assembly 340 may also drive generator assembly 310 to generate electricity using any other suitable technique such as, for example, via any desired energy transfer technique (e.g., magnetic, mechanical, electromechanical, thermal, and/or any other suitable technique).

At step 520, generator assembly 310 may power electrical component 425. For example, generated assembly 310 may transfer electricity generated based on energy transferred from conversion assembly 340 to electrical component 425 via any suitable technique (e.g., via electrical lines or wires, wireless power transfer, and/or any other suitable technique).

At step 525, controller 390 may receive data and/or signals from the exemplary disclosed sensors (e.g., sensors 430, 435, 440, 442, and/or any other desired sensors) including measurements obtained based on an operation of the exemplary disclosed sensors. For example, rotation measurement data and/or signals of shaft member 375, force and/or position measurement data and/or signals of mechanical assembly 305, and/or any other desired data and/or signals associated with mechanical assembly 305, generator assembly 310, and/or other components of system 300, body 320, and/or wheel assembly 325 may be transferred to controller 390. For example, sensed data measured by any suitable sensors of body 320 that may be a vehicle (e.g., sensors of a car or any other suitable vehicle or structure such as, for example, one or more vehicle sensors 442) may be provided to controller 390. The sensed data and/or signals may be transferred via any suitable technique (e.g., wire and/or wirelessly) for example via the exemplary disclosed communication techniques described herein.

At step 530, controller 390 may operate to determine whether or not to adjust an operation of control system 315. For example, controller 390 may determine whether or not to adjust a resistive load on a circuit of control system 315. Controller 390 may process the sensor data and/or signals received at step 525 in making this determination.

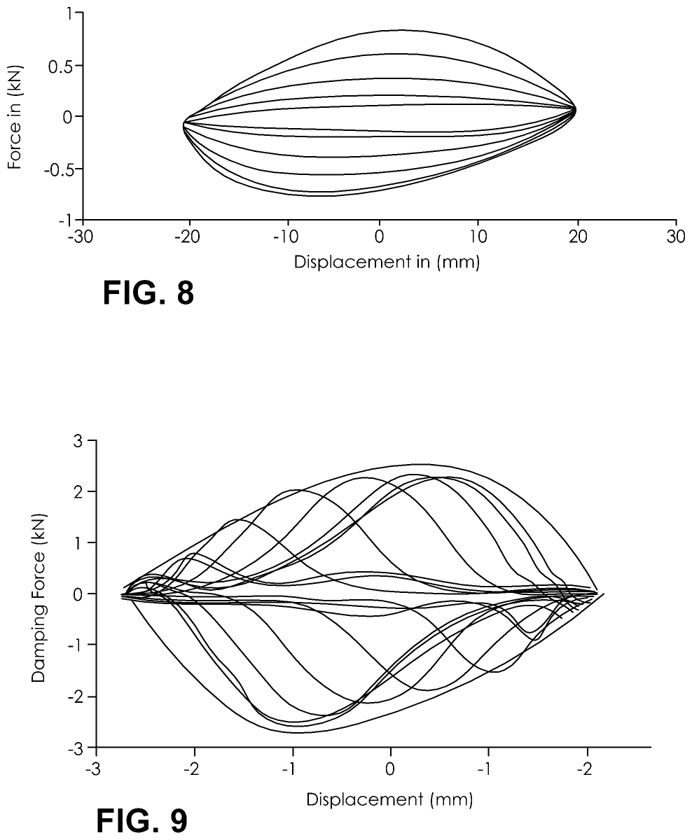

Controller 390 may utilize predetermined data and/or mapping in determining whether to make adjustments to control system 315. For example, controller 390 may utilize predetermined data (e.g., based on testing) relating force vs. displacement of damping assembly 335 for example as illustrated in FIGS. 8 and 9. For example, FIG. 8 illustrates an exemplary force vs. velocity curve associated with damping assembly 335 (e.g., a shock absorber). FIG. 9 illustrates a sinusoidal displacement associated with damping assembly 335. For example, FIG. 9 illustrates a plurality of sinusoidal displacements (e.g., force vs. displacement) associated with damping assembly 335 as various resistive loads (e.g., 10 ohm, 50 ohm, 100 ohm, and/or any other desired value) are applied to a circuit of control system 315. For example, each sinusoidal curve illustrated in FIG. 9 may correspond to a force vs. displacement curve of damping assembly 335 at a given resistive load (e.g., resistance) that may be provided by switch subsystem 385. For example, each resistive load may have a different torque curve associated with generator assembly 310. The torque curve may be a function of the rotational speed of generator assembly 310 and the effective electrical resistive load applied by switch subsystem 385 on the circuit of control system 315. Damping forces of damping assembly 335 may thereby be evaluated (e.g., mapped) at varying resistive loads (e.g., varying resistances that may be provided by switch subsystem 385). The sinusoidal curves illustrated in FIG. 9 may replicate (e.g., reproduce) the force vs. velocity curve illustrated in FIG. 8.

Based for example on the curves illustrated in FIG. 9 and the sensed data received at step 525, controller 390 may determine whether a resistive load applied to the circuit of control system 315 should be varied. For example, based on a damping force and/or any other suitable characteristics desired for the operation of damping assembly 335, controller 390 may determine a desired resistive load (e.g., based for example on FIG. 9) for switch subsystem 385 to apply to the electrical circuit of control system 315. Controller 390 may thereby select and control switch subsystem 385 to apply desired resistive loads to the electrical circuit of control system 315 to provide for desired characteristics of damping assembly 335 for example as described herein. Controller 390 may determine whether the resistive load should be varied and what level of resistive load should be applied based for example on sensed data received at step 525 (e.g., including data of desired conditions for example comfort of passengers and/or desired performance), user input (e.g., received via user device 415), predetermined algorithms, machine learning operations for example as described herein, and/or any other suitable criteria. For example, a resistive load determined (e.g., selected) by controller 390 may cause a desired behavior and/or characteristics of mechanical assembly 305 (e.g., damping assembly 335) for example as described herein. The effectiveness of system 300 for both energy regeneration and damping may thereby be provided based on the resistive load applied to control system 315 and/or generator assembly 310. For example, system 300 may operate to simultaneously provide both desired energy regeneration and desired damping based on the resistive load applied by control system 315. If controller 390 determines that a resistive load is to be switched (e.g., and to a desired level), process 500 proceeds to step 535.

At step 535, controller 390 may control switch subsystem 385 to switch a resistive load applied to an electrical circuit of control system 315 based on a resistive load selected (e.g., determined) at step 530. For example, controller 390 may control switch 395, which may operate with driver 400, capacitor 405, and resistor 410, to vary a resistive load on the circuit to a desired resistive load. For example in at least some exemplary embodiments, switch subsystem 385 may act as a PWM MOSFET switching circuit to variably adjust a resistive load on the circuit of control system 315, which may vary damping forces applied by damping assembly 335 as described herein. For example, by measuring the displacement and force values of mechanical assembly 305 (e.g., and generator assembly 310) through the exemplary disclosed sensors at step 525, sensed data may be fed to controller 390 to adjust switch subsystem 385 (e.g., adjust a PWM duty cycle applied to the MOSFET switch 395 in at least some exemplary embodiments). For example, switch 395 may rapidly switch between one or more resistors 410 being connected and disconnected from the electrical circuit of control system 315. The exemplary disclosed electrical circuit having varied resistive loads may provide for varied control of generator assembly 310 based on electrical flow across generator components 445 for example as illustrated in FIG. 6 and as described herein. For example, the exemplary configuration illustrated in FIG. 6 may be used to vary and apply desired resistive loads P to generator assembly 310 (e.g., to affect an inertia of generator assembly 310). Any other suitable technique may also be used to vary an operation of the electrical circuit of control system 315 to vary an operation of generator assembly 310.

Returning to FIG. 7, the damping characteristics of damping assembly 335 may be changed at step 540. For example, an operation of generator assembly 310 may be changed based on resistive load P applied to generator assembly 310 at step 535. Varying resistive load P applied to generator assembly 310 may vary a mechanical force (e.g., a force T such as a torque T) associated with shaft member 375. For example, the torque associated with causing shaft member 375 to rotate may be varied based on varying the resistive load applied at step 535. Controller 390 may thereby determine the torque associated with rotating shaft member 375 based on selecting the resistive load applied at step 535. For example, the selected torque may affect an operation of mechanical assembly 305, which may operate to rotate shaft member 375 for example as described herein.

Mechanical assembly 305 may rotate shaft member 375 based on vibration energy and other energy due to an operation of damping assembly 335 that may be converted to mechanical energy via conversion assembly 340. By varying the resistive load at step 535 to change the torque to rotate shaft member 375 at step 540, control system 315 may affect the characteristics of damping assembly 335. For example, by increasing or decreasing the torque for rotating shaft member 375, damping assembly 335 may operate differently (e.g., it may change characteristics such as stiffness, rigidity, and/or springiness of damping assembly 335). This change may affect a force that is applied by mechanical assembly 305 (e.g., damping assembly 335) to external bodies such as wheel assembly 325 and/or body 320. The characteristics of damping assembly 335 may thereby be effectively controlled by the torque associated with turning shaft member 375, which may be based on the resistive load applied by control system 315 to generator assembly 310. For example, generator assembly 310 may be dynamically changed between different torque curves that may be correlated to force vs. displacement curves of mechanical assembly 305 for example as illustrated in FIG. 9. System 300 may thereby provide for feedback-controlled variable damping forces to be applied by mechanical assembly 305 to an external body such as wheel assembly 325 and/or body 320. In at least some exemplary embodiments, resistive load P of the electrical circuit of control system 315 may be adjusted in real-time or near real-time to affect damping forces applied by mechanical assembly 305.

Process 500 may return to step 510 and repeat steps 510 through 540 for as many iterations as desired. If controller 390 determines at step 530 that resistive load is not to be adjusted, process 500 may proceed to step 545. At step 545, controller 390 may determine whether or not an operation is to be continued based for example on sensed data received at step 525 (e.g., including data of desired conditions for example comfort of passengers and/or desired performance), user input (e.g., received via user device 415), predetermined algorithms, machine learning operations for example as described herein, and/or any other suitable criteria. If the operation is to be continued, process 500 returns to step 510, and steps 510 through 545 may be repeated for as many iterations as desired. If the operation is not to be continued, process 500 ends at step 550.

In at least some exemplary embodiments, an effective electrical resistive load may be dynamically controlled (e.g., variably adjusted) by an in-series microcontroller circuit (e.g., control system 315) that adjusts a duty cycle of an unstable switching circuit (e.g., a transistor or relay such as switch 395) that may be configured to switch between different effective electrical resistive loads digitally through a microcontroller (e.g., controller 390) with pulse width modulation (PWM) techniques. For example, this may be accomplished by adjusting the torque of a generator (e.g., generator assembly 310) to adjust the damping force (e.g., of mechanical assembly 305). For example, since the damping force may be coupled to the torque of the generator, the damping force may be adjusted by changing the torque of the generator (e.g., generator assembly 310). For example, this may be achieved by changing values of a resistive load on the circuit (e.g., of control system 315) to produce a desired torque (e.g., associated with shaft member 375).

In at least some exemplary embodiments, a user may adjust damping criteria from within body 320 (e.g., a vehicle). For example, a user may adjust the ride profile of a drive to a selected mode, for example, a sport mode that may have an increased damping effect (e.g., to produce a smoother ride). In at least some exemplary embodiments, the lower or higher the damping effect of a ride profile of a vehicle, the more or less energy that is able to be harnessed and/or harvested. For example, if a user desires a relatively smooth ride, a user may select a mode such as a sport mode that may have the effect of increased damping to provide a smooth ride. For example, based on the user's selection, system 300 may determine (e.g., produce a calculation) of the expected energy that may be harnessed and/or harvested based on the ride profile selection. A user may be able to adjust a selected ride profile or mode for example by toggling or selecting between various damping options based on the provided expected energy harvesting calculated by the system. An effectiveness of system 300 for both energy regeneration and damping may thereby be provided.

In at least some exemplary embodiments, the exemplary disclosed regenerative shock absorbing device may be configured to determine (e.g., compute) desired criteria for energy harvesting while providing a desired ride profile. For example, system 300 may be configured to provide users with an estimation of energy harvesting based on a given ride profile to allow a user to select a ride profile with suitable energy harvesting between offered ride profiles. Also for example, within various offered ride profiles provided by controller 390, a user may choose a relatively smoother ride (e.g., less energy harvesting) or a relatively less smooth ride (e.g., more energy harvesting) to allow a user to both experience the comfort of the chosen ride profile while allowing a user to harvest and/or harness a desired amount of energy. A plurality of different ride profiles may be offered to a user such as, for example, sport or comfort modes.

In at least some exemplary embodiments, the exemplary disclosed sensors may measure conditions that may allow controller 390 (e.g., a closed-loop controller) to dynamically adjust a damping force of mechanical assembly 305 in real-time or near real-time. For example, a user may provide an input for a certain desired ride profile, and the closed-loop controller may automatically adjust the exemplary disclosed resistive load in real-time or near real-time to provide desired damping forces for a user's selected input (e.g., sport mode or comfort mode).

In at least some exemplary embodiments, mechanical assembly 305 may function as a sensor that is able to measure and/or provide other information relating to the conditions or characteristics of a designated feature or component or related external factors of body 320 (e.g., a vehicle), a drive or road profile, and/or other components or conditions of system 300. For example, system 300 (e.g., controller 390) may generate a report or other recognizable output that may be attributable to a condition or feature of system 300. For example, system 300 may be configured to measure (e.g., quantify) an output of generator assembly 310, control system 315, and/or mechanical assembly 305 (e.g., conversion assembly 340) to measure an electrical output and correlate it with a location of a vehicle to establish a record of road conditions.

In at least some exemplary embodiments, system 300 may provide a data collection feature. For example, mechanical assembly 305 (e.g., a regenerative shock absorber) may act as a sensor or a data collection device to collect data based on electrical current produced by the system (e.g., by generator assembly 310). For example, road surface characteristics of a given road may be quantified and collected based on the energy output (e.g., harvested energy) of the regenerative shock absorber and generator assembly 310 (e.g., the more energy generated and/or harnessed on a given road may indicate a bumpier ride and/or unstable road conditions). Additionally or alternatively, road surface characteristics of a given road (e.g., surface portion 330) may be quantified and collected based on the measurement of displacement (e.g., based on position sensor 440). For example, such collected data may be utilized by autonomous vehicle systems to automatically adjust the handling of the vehicle (e.g., via control system 315) based on measured road conditions.

In at least some exemplary embodiments, system 300 (e.g., mechanical assembly 305) may be configured to retrofit and/or integrate into body 320 (e.g., an existing vehicle). For example, mechanical assembly 305 may be configured to be directly replaced without changing existing vehicle electronics. Also, for example, system 300 may provide increased self-power suspension control.

In at least some exemplary embodiments, the exemplary disclosed method may be a method for controlling a mechanical assembly that includes a damping assembly. The exemplary disclosed method may include providing one or more sensors at at least one of the mechanical assembly or a generator assembly (e.g., generator assembly 310) that is operably connected to the mechanical assembly, providing an electrical circuit that is electrically connected to the generator assembly, sensing data of the at least one of the mechanical assembly or the generator assembly using the one or more sensors, varying an electrical load on the generator assembly using the electrical circuit based on the sensed data, and varying a mechanical force transferred between the generator assembly and the mechanical assembly based on varying the electrical load. The exemplary disclosed method may also include varying damping forces of the damping assembly based on varying the mechanical force. Varying the electrical load on the generator assembly may include varying a resistive load on the generator assembly. Varying the electrical load may include varying the resistive load using pulse width modulation via the electrical circuit that includes a MOSFET switching circuit. The exemplary disclosed method may further include converting the vibration energy of the damping assembly into the mechanical force using a conversion assembly of the mechanical assembly. The exemplary disclosed method may also include transferring the mechanical force that is torque between the conversion assembly and the generator assembly via a shaft member. The exemplary disclosed method may further include driving the generator assembly to produce electricity based on driving the generator assembly with the mechanical force. The exemplary disclosed method may also include transferring the electricity to an electrical component of a vehicle, wherein the damping assembly is a shock absorber of the vehicle. The exemplary disclosed method may further include recording road surface conditions of a road on which the vehicle travels based on the amount of electricity produced by the generator assembly. Sensing data of at least one of the mechanical assembly or the generator assembly may include sensing rotation of a shaft member operably connecting the mechanical assembly and the generator assembly and sensing a force and a position of the damping assembly. The exemplary disclosed method may also include varying the electrical load on the generator assembly using the electrical circuit based on vehicle data of the vehicle sensed by vehicle sensors of the vehicle.

In at least some exemplary embodiments, the exemplary disclosed apparatus may be configured to be connected to a generator assembly and a damping assembly. The exemplary disclosed apparatus may include a conversion assembly (e.g., conversion assembly 340) configured to be operably connected between the generator assembly and the damping assembly, a structural member (e.g., shaft member 375) operably connecting the conversion assembly and the generator assembly, an electrical circuit that is configured to be electrically connected to the generator assembly, and one or more sensors configured to sense at least one of the generator assembly or the damping assembly. The electrical circuit may be configured to vary an electrical load on the generator assembly based on the sensing of the one or more sensors. Varying the electrical load on the generator assembly may vary a mechanical force transferred by the structural member. The conversion assembly may be configured to convert vibration energy of the damping assembly to the mechanical force transferred by the structural member. The conversion assembly and the damping assembly may together form a regenerative shock absorber of a vehicle. The structural member may be a shaft member having a D-shaped cross-section. The electrical circuit may include a MOSFET transistor, a MOSFET driver, a resistor, and a capacitor.

In at least some exemplary embodiments, the exemplary disclosed method may be a method for controlling a regenerative shock absorber of a vehicle. The exemplary disclosed method may include providing one or more sensors at at least one of the regenerative shock absorbers or a generator assembly (e.g., generator assembly 310) that is operably connected to the regenerative shock absorber, providing an electrical circuit that is electrically connected to the generator assembly, sensing data of the at least one of the regenerative shock absorber, the generator assembly, or the vehicle using at least one of the one or more sensors or one or more vehicle sensors of the vehicle, varying a resistive load on the generator assembly using the electrical circuit based on the sensed data, and varying a mechanical force transferred between the generator assembly and the regenerative shock absorber based on varying the resistive load. Varying the mechanical force transferred between the generator assembly and the regenerative shock absorber may include varying a torque of a shaft member that operably connects the generator assembly and the regenerative shock absorber. The exemplary disclosed method may also include varying an amount of electricity generated by the generator assembly and transferred to an electrical component of the vehicle based on varying the torque. The exemplary disclosed method may further include converting the vibration energy of a damping assembly of the regenerative shock absorber to the mechanical force via a conversion assembly including a plurality of gears.

The exemplary disclosed system, apparatus, and method may provide an efficient and effective technique for varying and controlling characteristics of a regenerative energy device. The exemplary disclosed system, apparatus, and method may also provide for control of a regenerative energy device to simultaneously provide both desired energy regeneration and desired damping to systems such as vehicular systems. For example, the exemplary disclosed system, apparatus, and method may provide for a regenerative energy device to provide feedback-controlled variable damping forces to an external body.

An illustrative representation of a computing device appropriate for use with embodiments of the system of the present disclosure is shown in FIG. 10. The computing device 100 can generally be comprised of a Central Processing Unit (CPU, 101), optional further processing units including a graphics processing unit (GPU), a Random Access Memory (RAM, 102), a motherboard 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wi-Fi, Bluetooth, USB). Useful examples include, but are not limited to, personal computers, smartphones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration, and many standardized communication links are well known to one skilled in the art, as explained in more detail and illustrated by FIG. 11, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured, and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 11, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 11, exchange of information through the WAN 201 or other networks may occur through one or more high-speed connections. In some cases, high-speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high-speed connections, embodiments of the present disclosure may be utilized with connections of any speed.

Components or modules of the system may connect to server 203 via WAN 201 or other networks in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the WAN 201. One of ordinary skill in the art will appreciate that there are numerous ways that a component or module may connect to server 203 via WAN 201 or other networks, and embodiments of the present disclosure are contemplated for use with any method for connecting to server 203 via WAN 201 or other networks. Furthermore, server 203 could be comprised of a personal computing device, such as a smartphone, acting as a host for other computing devices to connect to.

The communications means of the system may be any means for communicating data, including text, binary data, image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The exemplary disclosed system may for example utilize collected data to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary disclosed system may utilize neural network-based artificial intelligence to predictively assess risk. For example, the exemplary neural network may include a plurality of input nodes that may be interconnected and/or networked with a plurality of additional and/or other processing nodes to determine a predicted result (e.g., a location as described for example herein).

For example, exemplary artificial intelligence processes may include filtering and processing datasets, processing to simplify datasets by statistically eliminating irrelevant, invariant, or superfluous variables or creating new variables which are an amalgamation of a set of underlying variables, and/or processing for splitting datasets into train, test and validate datasets using at least a stratified sampling technique. For example, the prediction algorithms and approach may include regression models, tree-based approaches, logistic regression, Bayesian methods, deep learning and neural networks both as a stand-alone and on an ensemble basis, and the final prediction may be based on the model/structure which delivers the highest degree of accuracy and stability as judged by implementation against the test and validate datasets. Also, for example, exemplary artificial intelligence processes may include processing for training a machine learning model to make predictions based on data collected by the exemplary disclosed sensors.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application-specific integrated circuits, or the like, which can be suitably employed or configured to process computer program instructions, execute computer logic, store computer data, and so on. Throughout this disclosure and elsewhere a computing device can include any and all suitable combinations of at least one general-purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction techniques for performing the specified functions, and so on.

It will be appreciated that computer program instructions may include computer executable code. A variety of languages for expressing computer program instructions are possible, including without limitation Kotlin, Swift, C #, PHP, C, C++, Assembler, Java, HTML, JavaScript, CSS, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of mobile applications, firmware for monitoring devices, web-based computer software, and so on, which includes client/server software, software-as-a-service, peer-to-peer software, or the like.

In some embodiments, a computing device enables the execution of computer program instructions including multiple programs or threads. The multiple programs or threads may be processed more or less simultaneously to enhance the utilization of the processor and to facilitate substantially simultaneous functions. By way of implementation, any and all methods, program codes, program instructions, and the like described herein may be implemented in one or more threads. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A method for controlling a mechanical assembly that includes a damping assembly, comprising:
providing one or more sensors at at least one of the mechanical assembly or a generator assembly that is operably connected to the mechanical assembly;
providing an electrical circuit that is electrically connected to the generator assembly;
sensing data of the at least one of the mechanical assembly or the generator assembly using the one or more sensors;
varying an electrical load on the generator assembly using the electrical circuit based on the sensed data; and
varying a mechanical force transferred between the generator assembly and the mechanical assembly based on varying the electrical load.

2. The method of claim 1, further comprising varying damping forces of the damping assembly based on varying the mechanical force.

3. The method of claim 1, wherein varying the electrical load on the generator assembly includes varying a resistive load on the generator assembly.

4. The method of claim 1, wherein varying the electrical load includes varying the resistive load using pulse width modulation via the electrical circuit that includes a MOSFET switching circuit.

5. The method of claim 1, further comprising converting vibration energy of the damping assembly into the mechanical force using a conversion assembly of the mechanical assembly.

6. The method of claim 5, further comprising transferring the mechanical force that is torque between the conversion assembly and the generator assembly via a shaft member.

7. The method of claim 1, further comprising driving the generator assembly to produce electricity based on driving the generator assembly with the mechanical force.

8. The method of claim 7, further comprising transferring the electricity to an electrical component of a vehicle, wherein the damping assembly is a shock absorber of the vehicle.

9. The method of claim 8, further comprising recording road surface conditions of a road on which the vehicle travels based on the amount of electricity produced by the generator assembly.

10. The method of claim 1, wherein sensing data of the at least one of the mechanical assembly or the generator assembly includes sensing rotation of a shaft member operably connecting the mechanical assembly and the generator assembly, and sensing a force and a position of the damping assembly.

11. The method of claim 8, further comprising varying the electrical load on the generator assembly using the electrical circuit based on vehicle data of the vehicle sensed by vehicle sensors of the vehicle.

12. An apparatus configured to be connected to a generator assembly and a damping assembly, comprising:
a conversion assembly configured to be operably connected between the generator assembly and the damping assembly, a structural member operably connecting the conversion assembly and the generator assembly;
an electrical circuit that is configured to be electrically connected to the generator assembly; and
one or more sensors configured to sense at least one of the generator assembly or the damping assembly;
wherein the electrical circuit is configured to vary an electrical load on the generator assembly based on the sensing of the one or more sensors; and
wherein varying the electrical load on the generator assembly varies a mechanical force transferred by the structural member.

13. The apparatus of claim 12, wherein the conversion assembly is configured to convert vibration energy of the damping assembly to the mechanical force transferred by the structural member.

14. The apparatus of claim 12, wherein the conversion assembly and the damping assembly together form a regenerative shock absorber of a vehicle.

15. The apparatus of claim 12, wherein the structural member is a shaft member having a D-shaped cross-section.

16. The apparatus of claim 12, wherein the electrical circuit includes a MOSFET transistor, a MOSFET driver, a resistor, and a capacitor.

17. A method for controlling a regenerative shock absorber of a vehicle, comprising:
providing one or more sensors at at least one of the regenerative shock absorber or a generator assembly that is operably connected to the regenerative shock absorber;
providing an electrical circuit that is electrically connected to the generator assembly;
sensing data of the at least one of the regenerative shock absorber, the generator assembly, or the vehicle using at least one of the one or more sensors or one or more vehicle sensors of the vehicle;
varying a resistive load on the generator assembly using the electrical circuit based on the sensed data; and
varying a mechanical force transferred between the generator assembly and the regenerative shock absorber based on varying the resistive load.

18. The method of claim 17, wherein varying the mechanical force transferred between the generator assembly and the regenerative shock absorber includes varying a torque of a shaft member that operably connects the generator assembly and the regenerative shock absorber.

19. The method of claim 18, further comprising varying an amount of electricity generated by the generator assembly and transferred to an electrical component of the vehicle based on varying the torque.

20. The method of claim 17, further comprising converting vibration energy of a damping assembly of the regenerative shock absorber to the mechanical force via a conversion assembly including a plurality of gears.
